(19) United States
(12) Patent Application Publication
(10) Pub. No.: US 2010/0322780 A1
(43) Pub. Date: Dec. 23, 2010

(54) SOLDER COATING, METHOD FOR COATING A COMPONENT, COMPONENT, AND ADHESIVE TAPE HAVING A SOLDER COATING

(75) Inventor: Karl-Heinz Manier, Scheyern (DE)

Correspondence Address: BARLOW, JOSEPHS & HOLMES, LTD., 101 DYER STREET, 5TH FLOOR, PROVIDENCE, RI, 02903, US

(73) Assignee: MTU AERO ENGINES GMBH, München (DE)

(21) Appl. No.: 12/811,314

(22) PCT Filed: Dec. 18, 2008
(86) PCT No.: PCT/DE2008/002134

§ 371 Date: Sep. 10, 2010

(30) Foreign Application Priority Data
Jan. 3, 2008 (DE) 10 2008 003 100.3

(51) Int. Cl. F04D 29/38; C09J 5/06; B23K 35/14

(52) U.S. Cl. 416/241 R; 428/621; 228/56.3

(57) ABSTRACT

A solder coating (10), particularly for a blade tip of a gas turbine, comprises at least two superimposed layers (14, 16). A first layer (14) comprises a solder and a binding agent. A second layer (16) comprises particles (18) of an MCrAlY alloy, grinding particles (20) and a binding agent. The heating of solder coating (10) leads to at least a partial dissolution of particles (18) of the MCrAlY alloy by means of the liquid solder before the MCrAlY alloy melts.

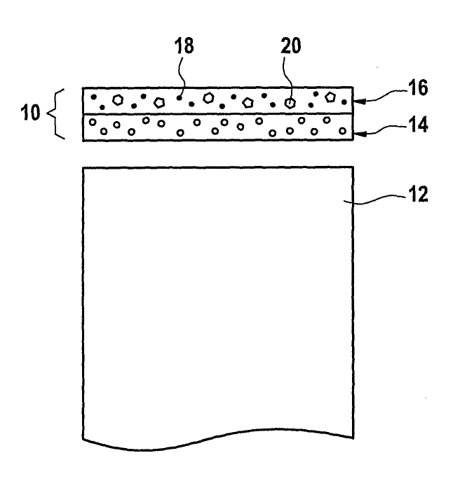

The invention relates to a solder coating, particularly for a blade tip of a gas turbine, comprising at least two superimposed layers, a first layer comprising a solder and a second layer comprising particles of an MCrAlY alloy as well as grinding particles. The invention further relates to a method for coating a component and a component having a solder coating.

Solder coatings are employed, in particular, in aircraft engines. In order to minimize pressure losses between the individual engine stages of a gas turbine, an optimal sealing between rotor and housing of the turbine is necessary. In order to achieve a radial distance that is as small as possible between the ends (tips) of the rotating turbine blades and the housing, the blade tips are provided with a soldered cladding having an overdimension. When the turbine is run in, the blade tip cladding comes into friction contact with the housing and hollows out a cavity so that the turbine blade no longer comes into direct contact with the housing.

It has been shown that a cladding containing grinding particles of cubic boron nitride (CBN) that are embedded in an MCrAlY matrix is suitable for this purpose. Initial material for such a blade tip cladding is a solder coating which is introduced, for example, in the form of an adhesive tape on the turbine blade tips and is then thermally treated. The production of the MCrAlY matrix by mixing molten MCrAlY power with liquid solder, however, requires very high temperatures. If a solder coating is used, in which the solder is provided in a layer facing away from the component, and the MCrAlY powder and the grinding particles are provided in a layer facing the component, large temperature gradients arise due to the impeded heat flow from the turbine blade tips to the solder, which may lead to the melting of the turbine blade tips or to the crystallizing of the turbine blade material.

A solder coating of this type and a method for the production of a blade tip cladding by means of which this problem can be circumvented are known from U.S. Pat. No. 7,063,250 B2. The solder coating comprises a metal solder layer which is mixed with boron and a material layer that is introduced thereon and that contains CBN grinding particles and MCrAlY particles embedded in a binding agent. The layer formation is introduced in the form of an adhesive tape onto the blade tip and is heated to approximately 600° C. together with the rotor blade in a vacuum furnace, until the binding agent in the material layer has volatilized. Subsequently, the furnace is heated to above the melting point of the solder (approximately 1000° C.), and the volatilized solder penetrates into the material layer. The boron of the solder layer diffuses into the MCrAlY particles and reduces the melting point thereof. The MCrAlY particles are converted in this way to a molten state, which makes possible a mixing of the MCrAlY alloy with the already liquid solder. If this process is concluded, a solid layer containing CBN grinding particles that are embedded in an MCrAlY matrix are formed after cooling. With the heating of the blade tips, however, in addition, there is the danger of the melting or crystallizing of the blade tip material.

The object of the invention is to solve the above-named problem of undesired melting in another way.

For this purpose, the invention proposes a solder coating of the type named initially, in which the composition of the solder and of the MCrAlY alloy are fine-tuned to one another, so that a heating of the solder coating leads to at least a partial dissolution of the particles of the MCrAlY alloy by means of the liquid solder, before the MCrAlY alloy melts, i.e. without the MCrAlY alloy liquefying due to the temperature. The invention is based on the knowledge that a soldered cladding which is produced from a solder coating containing grinding particles and MCrAlY particles does not absolutely require the melting of the MCrAlY particles. The invention rather provides that the MCrAlY particles dissolve in the liquid solder, similar to salt in water. This is achieved by fine-tuning the material according to the invention at a solder temperature that lies below the melting point of the MCrAlY alloy. Costly additive agents for lowering the melting point of the MCrAlY particles, such as, e.g., the addition of boron to the solder, can also be dispensed with. Another advantage of the invention is the short holding time, i.e., the component to be coated needs to be subjected to the solder temperature only for a relatively short time span, since the dissolving of the MCrAlY particles in the liquid solder requires little time. The danger of undesired side effects, such as the melting or crystallization of the component material is thus clearly reduced. Mass production correspondingly is more stable, the waste is less and little post-processing is necessary.

According to the preferred embodiment of the invention, the solder contains the following components: Co, Cr, Ni, Si, C. In this case, Si works to reduce the melting point, but this is effected exclusively for the solder; Si has no effect on the melting point of the MCrAlY alloy. For better processing of the solder coating, it is advantageous if the first and/or the second layer additionally contains a binding agent. In this way, the materials can be processed more easily and more flexibly. Also, a binding agent does not influence the method, since it volatilizes when the coating is heated. The preferred percentages by weight of the solder components lie in the following ranges:

Co: 50 to 60%, preferably 55.6%;

Cr: 15 to 22%, preferably 19%;

Ni: 12 to 22%, preferably 17%;

Si: 2 to 15%, preferably 8%;

C: 0.1 to 1%, preferably 0.4%.

A solder based on nickel is also possible, in which the above-indicated values for cobalt and nickel are interchanged for these two elements.

The MCrAlY alloy preferably contains the following percentages by weight:

Cr: 22%±5%, preferably ±22.5%;

Al: 10%±2%, preferably ±10%;

Y: 0.5 to 1.5%.

As an additional component, the MCrAlY alloy preferably contains nickel.

Advantageously, a small percentage of Si also, of course, does not act to reduce the melting point. Finally, the MCrAlY alloy can also be based on cobalt.

It has been shown that the above-indicated material compositions with respect to the necessary process parameters (temperature, time, pressure, etc.) and the properties of the obtained coating lead to optimal results.

The invention also creates a method for coating a component, in particular, a blade tip of a gas turbine, having the following steps:

Introducing a solder coating according to the invention onto a surface of the component, so that the first layer is facing the component and the second layer is facing away from the component;

Heating of the solder coating to a solder temperature at which the solder has liquefied and the heating leads to at least a partial dissolution of the particles of the MCrAlY alloy by means of the liquid solder.

Further, the invention also creates a component with a solder coating according to the invention, in which the solder coating is introduced onto the component in such a way that the first layer is facing the component and the second layer is facing away from the component. The component is particularly a blade tip of a gas turbine that can be disposed both in the compressor region as well as in the hot-gas turbine region of the gas turbine.

Finally, the invention also creates an adhesive tape with an adhesive layer and a solder coating according to the invention, in which the first layer of the solder coating is disposed between the adhesive layer and the second layer of the solder coating.

Additional features and advantages of the invention result from the following description and from the appended drawing, to which reference is made. In the drawing, the single FIGURE shows a solder coating according to the invention and a component to be coated.

A solder coating 10 is shown in the FIGURE, which serves for the production of a cladding for a component 12, in particular for a blade tip of a gas turbine. Solder coating 10 comprises a solder layer 14 containing a boron-free solder and a binding agent. The solder is an alloy of the components cobalt (Co), chromium (Cr), nickel (Ni), silicon (Si), and carbon (C) with the following percentages by weight:

Co: 50 to 60%, preferably 55.6%;

Cr: 15 to 22%, preferably 19%;

Ni: 12 to 22%, preferably 17%;

Si: 2 to 15%, preferably 8%;

C: 0.1 to 1%, preferably 0.4%.

A layer of material 16, which contains MCrAlY particles 18 (powder particles of an MCrAlY alloy), grinding particles 20 and a binding agent, is introduced on solder layer 14. The MCrAlY alloy contains nickel (Ni), chromium (Cr), aluminum (Al) and yttrium (Y) with the following percentages by weight:

Cr: 22%±5%, preferably ±22.5%;

Al: 10%±2%, preferably ±10%;

Y: 0.5 to 1.5%.

Grinding particles 20 are formed of cubic boron nitride (CBN) and have a diameter of approximately 50 to 200 μm.

The thickness of solder layer 14 and material layer 16 overall amounts preferably to approximately 0.3 mm, whereby in general, solder layer 14 amounts to approximately 60% and material layer 16 amounts to approximately 40% of the total thickness. The CBN grinding particles 20 make up approximately 7.5%, the solder containing the binding agent approximately 41.1% and the MCrAlY particles 18 containing the binding agent approximately 51.4% of the total weight of the solder coating 10.

Solder coating 10 has a (not shown) adhesive layer, which is disposed underneath solder layer 14, as a means for fastening to component 12. Thus, solder coating 10 can be introduced on component 12 in such a way that solder layer 14 is facing component 12 and material layer 16 is facing away from component 12.

The method for coating component 12 (here: the method for the production of the cladding for the turbine blade tips) is similar to the initially described method according to the prior art, but is distinguished, however, particularly with respect to solder coating 10 which is used and the effects occurring during heating.

After introducing solder coating 10 onto the surface of component 12, the entire component 12 is heated in vacuum or protective gas by induction locally at the blade tip to a solder temperature at which the solder is present in the molten state, but not the MCrAlY particles 18. Since solder layer 14 is facing component 12, a good transfer of heat occurs from component 12 to the solder. The heating leads to the circumstance that MCrAlY particles 18 dissolve at least partially in the liquid solder without directly melting.

Component 12 is subjected to the solder temperature only over a relatively short time span (holding time), preferably for a time span of less than 5 minutes, since the dissolution of the MCrAlY particles 18 only requires a short time. Experiments have shown that the above-indicated material compositions create optimal pre-conditions for the dissolution process with respect to required temperature and holding time. After cooling the liquid solder plus soldered MCrAlY alloy, a dendritic structure is formed, although MCrAlY particles that are still incompletely dissolved are found in part in the layer.

As a result, the cooled component 12 comprises a solid layer containing an MCrAlY matrix and CBN grinding particles embedded therein.

The invention, of course, is not limited to the described application, but can find application also in other technical fields.

1. A solder coating, in particular for a blade tip of a gas turbine, comprising at least two superimposed layers (14, 16), wherein a first layer (14) comprises a solder and a second layer (16) comprises particles (18) of an MCrAlY alloy as well as grinding particles (20), hereby characterized in that the combining of the solder and the MCrAlY alloy are adapted to one another such that the heating of the solder coating (10) leads to at a least partial dissolution of particles (18) of the MCrAlY alloy by means of the liquid solder before the MCrAlY alloy melts.

2. The solder coating according to claim 1, further characterized in that the solder is boron-free.

3. The solder coating according to claim 1, further characterized in that the solder contains the following components: Co, Cr, Ni, Si, C.

4. The solder coating according to claim 3, further characterized in that the percentages by weight of the solder components lie in the following ranges:
Co: 50 to 60%, preferably 55.6%;
Cr: 15 to 22%, preferably 19%;
Ni: 12 to 22%, preferably 17%;
Si: 2 to 15%, preferably 8%;
C: 0.1 to 1%, preferably 0.4%.

5. The solder coating according to claim 1, further characterized in that the MCrAlY alloy contains the following in percentages by weight:
Cr: 22%±5%, preferably ±22.5%;
Al: 10%±2%, preferably ±10%;
Y: 0.5 to 1.5%.

6. The solder coating according to claim 1, further characterized in that the MCrAlY alloy contains Ni.

7. The solder coating according to claim 1, further characterized in that the grinding particles 20 are formed of cubic boron nitride and have a diameter of approximately 50 to 200 μm.

8. The solder coating according to claim 1, further characterized in that a means is provided for a fastening of solder coating (10) to a component (12), in which the first layer (14) is facing component (12) and the second layer (16) is facing away from component (12).

9. The method for coating a component 12, in particular a blade tip of a gas turbine, with the following steps:
Introducing the solder coating (10) according to one of the preceding claims onto a surface of component (12), so that the first layer (14) is facing component (12) and the second layer (16) is facing away from component (12);
Heating the solder coating (10) to a solder temperature at which the solder has liquefied and the heating leads to at least a partial dissolution of particles (18) of the MCrAlY alloy by means of the liquid solder.

10. The method according to claim 9, further characterized in that the solder temperature lies below the melting point of the MCrAlY alloy.

11. A component, in particular a blade tip of a gas turbine, having a solder coating (10) according to claim 1, characterized in that solder coating (10) is introduced onto component (12) so that the first layer (14) is facing component (12) and the second layer (16) is facing away from component (12).

12. An adhesive tape, with an adhesive layer and a solder coating according to claim 1, further characterized in that the first layer (14) of solder coating (10) is disposed between the adhesive layer and the second layer (16) of solder coating (10).
